(19) United States
(12) Patent Application Publication
(10) Pub. No.: US 2015/0050946 A1
(43) Pub. Date: Feb. 19, 2015

(54) SUPPORTING STORAGE OF DATA

(71) Applicant: Nokia Corporation, Espoo (FI)

(72) Inventors: Lauri Aarne Johannes Wirola, Tampere (FI); Tommi Antero Laine, Tampere (FI); Jari Syrjarinne, Tampere (FI)

(21) Appl. No.: 14/383,551

(22) PCT Filed: Mar. 15, 2012
(86) PCT No.: PCT/IB2012/051230

§ 371 Date: Sep. 6, 2014

(51) Int. Cl. H04W 24/10; H04W 64/00

(52) U.S. Cl. CPC H04W 24/10; H04W 64/003
USPC 455/456.1

(57) ABSTRACT

An apparatus determines for each of a plurality of sub-areas of an area an amount of measurement results that are received for the respective sub-area. The apparatus further determines a sub-area, for which the determined amount of measurement results exceeds a reference value. The apparatus further sets up for the determined sub-area a focus grid with a density that is higher than a lowest density of a basic grid assigned to the area. Measurement results received for the determined sub-area may then be stored at least with a mapping to grid points of the focus grid.

### FIELD OF THE DISCLOSURE

The invention relates to the field of storage of data, and more specifically to supporting storage of measurement results with a mapping to grid points of a grid.

### BACKGROUND

Data may be stored with a mapping to grid points of a grid for instance in order to reflect the applicability of different pieces of data for different locations, while enabling at the same time a limitation of the total amount of data that has to be stored.

For example, modern global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where further models may be generated based on the data for positioning purposes. Such further models can be coverage area estimates or base station position and radio channel models. In the end, these refined radio models may be transferred back to user terminals for use in position determination.

A radio channel model, for instance, may consists of a base station position and a pathloss model, or a plurality of pathloss models in the case of sectorized models, the base station being an exemplary node of a communication network. Before the model can be calculated, a certain amount of data including measurement results has to be collected within the coverage area of the base station. In a community-based collection effort, data need to be accumulated over time in order to obtain a sufficient amount of data. The data received at a server thus has to be stored in order to be usable for refinement into further models.

It would be possible to store the measurement results and the associated locations as received. Alternatively, the received measurement results could be associated with grid points of a grid that represent locations close to the respective measuring position, in order to reduce the storage requirements.

### SUMMARY OF SOME EMBODIMENTS OF THE INVENTION

A method is described, which comprises at an apparatus determining for each of a plurality of sub-areas of an area an amount of measurement results that are received for the respective sub-area. The method further comprises determining a sub-area, for which the determined amount of measurement results exceeds a reference value. The method further comprises setting up for the determined sub-area a focus grid with a density that is higher than a lowest density of a basic grid assigned to the area, wherein measurement results received for the determined sub-area are to be stored at least with a mapping to grid points of the focus grid.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a non-transitory computer readable storage medium is described, in which computer program code is stored. The computer program code causes an apparatus to realize the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Moreover a system is described, which comprises any of the described apparatuses and a mobile terminal providing the measurement results.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described methods are information providing methods, and the described first apparatus is an information providing apparatus. In one embodiment, the means of the described first apparatus are processing means.

In certain embodiments of the described methods, the methods are methods for supporting storage of data. In certain embodiments of the described apparatuses, the apparatuses are apparatuses for supporting storage of data.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus according to an exemplary embodiment of the invention;

FIG. 2 is a flow chart illustrating a method according to an exemplary embodiment of the invention;

FIG. 3 is a schematic block diagram of a system according to an exemplary embodiment of the invention;

FIG. 4 is a flow chart illustrating an exemplary operation in the system of FIG. 3;

FIG. 5 is a diagram illustrating a basic grid and a focus grid for a cell area; and

FIG. 6 is a diagram illustrating an activity grid and a focus grid for a cell area.

### DETAILED DESCRIPTION OF THE FIGURES

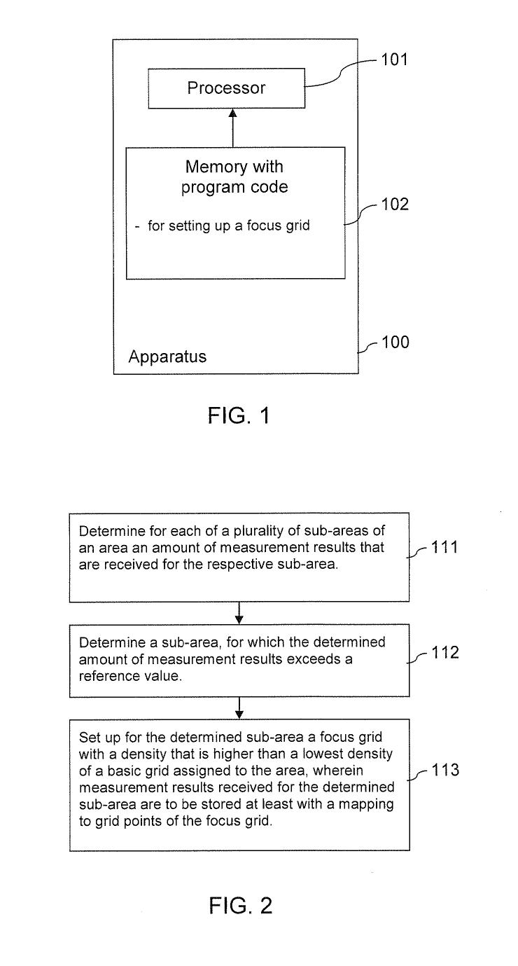

FIG. 1 is a schematic block diagram of an apparatus 100. Apparatus 100 comprises a processor 101 and, linked to processor 101, a memory 102. Memory 102 stores computer program code for setting up a focus grid for a sub-area of an area. Processor 101 is configured to execute computer program code stored in memory 102 in order to cause an apparatus to perform desired actions.

Apparatus 100 could be a server or any other device, for instance a mobile terminal. Apparatus 100 could equally be a module for a server or for any other device, like a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus determines for each of a plurality of sub-areas of an area an amount of measurement results that are received for the respective sub-area. (action 111)

The apparatus furthermore determines a sub-area, for which the determined amount of measurement results exceeds a reference value. (action 112)

The apparatus furthermore sets up for the determined sub-area a focus grid with a density that is higher than a lowest density of a basic grid assigned to the area. Measurement results received for the determined sub-area may then be stored at least with a mapping to grid points of the focus grid. (action 113)

It is to be understood that the terms “focus grid” and “basic grid” are only used for descriptively differentiating between the grids. They could also simply be referred to, for instance, as “first grid” and “second grid”, respectively.

Certain embodiments of the invention may thus enable an apparatus to support a setting up of focus grids for sub-areas for which a comparatively large number of measurement results is received. The focus grids may then be used as a basis for storing measurement results for these sub-areas with a higher spatial resolution than used for measurement results for other sub-areas, since the focus grids have a higher density than a basic grid that is used as a basis for storing measurement results for other sub-areas.

Certain embodiments of the invention may thus have the effect that a high accuracy is achieved in sub-areas if required, while in other sub-areas accuracy may be traded in for less storage consumption. The comparison to a reference value allows determining which sub-areas are the most active and thus the most interesting.

Apparatus 100 illustrated in FIG. 1 and the operation illustrated in FIG. 2 may be implemented and refined in various ways.

In an exemplary embodiment, the measurement results are results of measurements on signals from a particular node of a communication network or of signals of a particular cell of a communication network.

The measurement results may be provided for instance by mobile terminals, for example by communication terminals, like mobile phones, smart phones, laptops, tablet computers, etc. They could comprise for instance the results of measurements on terrestrial radio signals from the nodes of a communication system determined or collected at the mobile terminals at a respective location. Such measurements could comprise for instance signal strength measurements, pathloss measurements, timing advance measurements, round-trip-time measurements, etc.

The node could be a node of a cellular communication system, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. Alternatively, the node could be for example a node of a non-cellular communication system, like WLAN, Bluetooth and Zigbee, etc. The node of a cellular communication system could be for instance a transceiver or a base station of the cellular communication system. In general, a node of a cellular communication system could be an entity serving exactly one cell, or an entity serving a plurality of cells from a single position. The node of a WLAN could be a WLAN access point.

Mobile terminals providing measurement results could provide at the same time an indication of their current position, in order to enable an identification of a sub-area for which the measurement results are valid.

In an exemplary embodiment, the amount of measurement results is a number of measurement results per time period, but it could also be for instance a number that is simply incremented with each new measurement result.

In an exemplary embodiment, the reference value is a fixed threshold value. In an alternative embodiment, the reference value is a variable threshold value. A variable threshold value could be for instance an average over an amount of measurement results from all considered sub-areas of an area, or the median of the amount of measurement results from all considered sub-areas of an area. Using a fixed threshold value may have the effect that less processing is required. Using an adaptive threshold value may have the effect that it is more flexible and enables an adaptation to different situations.

In an exemplary embodiment, the density of the basic grid could be fixed. Alternatively, it could be adapted globally or locally to balance storage consumption and accuracy. For instance, if the area is an area in which the signals of a particular cell can be observed and a basic grid is assigned to specifically to this cell area, the density of a basic grid could be set to a value that is used in common for the basic grids for all cell areas, or the density of a basic grid could be selected individually for each cell area.

In an exemplary embodiment, only those measurement results that are received for a sub-area to which no focus grid is assigned are stored with a mapping to grid points of the basic grid. In an alternative embodiment, all measurement results that are received for the area are stored at least with a mapping to grid points of the basic grid.

In an exemplary embodiment, the focus grid is provided in addition to the basic grid. Thus, there may be a plurality of grids defined for a particular area, for instance for the area in which signals of particular cell are observable. In an alternative embodiment, the focus grid is integrated into the basic grid.

In an exemplary embodiment, a plurality of focus grids may be assigned to a plurality of sub-areas of the area. Each of the focus grids for the sub-areas of the area could have the same density or an individually selected density. If an additional focus grid is set up at some stage for a sub-area of an area to which a basic grid with integrated focus grid is associated, the density of the new focus grid only has to be higher than the density of the original basic grid and thus higher than the lowest density of the current basic grid.

In an exemplary embodiment, a single focus grid could be set up for one or more sub-areas. In a first alternative, all of these sub-areas have to be sub-areas for which a determined amount of measurement results exceeds a reference value. In a second alternative, at least one of these sub-areas has to be a sub-area for which a determined amount of measurement results exceeds a reference value.

In an exemplary embodiment, setting up a focus grid comprises storing at least one factor defining a density of the focus grid in relation to a density of a reference grid. The reference grid could be the basic grid or another reference grid, for instance a common reference grid that is valid for all considered areas. For obtaining the reference grid, the Earth surface may for example be virtually divided by a grid having a certain grid spacing in latitude and longitude directions, for example 5 μDeg. In latitude direction, this corresponds to 0.56 m along the equator at the equator, and to 0.28 m along the latitude circle at 60° latitude.

The density of the basic grid may equally be defined by a factor compared a reference grid.

In an alternative embodiment, a focus grid and/or a basic grid could also be set up by storing for each grid point of the respective grid co-ordinates corresponding to a location on the surface of Earth.

If a focus grid and/or a basic grid is adaptive, the density of the respective grid may be adapted by adding new row between existing rows and/or adding a new column between existing columns, or by removing existing rows and/or columns and data that has been stored with a mapping to grid points of the removed columns and rows.

In an exemplary embodiment, measurement results are stored for a sub-area for which a respective focus grid has been set up with a mapping to grid points of the respective focus grid, taking account of the grid density of the respective focus grid.

In an exemplary embodiment, measurement results that have been stored with a mapping to grid points of a focus grid are retrieved, and the measurement results are processed taking account of the grid density of the respective focus grid. The measurement results can be used for instance for supporting a positioning of a mobile terminal directly or indirectly, at a server or at the mobile terminal.

When using a grid-based approach in positioning, the accuracy that can be achieved in the positioning is approximately half of the grid resolution. That is, if the grid density is 400 meters, then the best achievable accuracy is in the order of 200 meters. In an area covered by a cell there may be sub-areas, like residential areas etc., in which, for example, an accuracy of 50 meters is desirable, which requires a grid density of 100 meters. However, in the same cell area there may be large sub-areas, which are not that important to users and for which for example an accuracy of 200 meters would be acceptable.

In a conventional grid approach, the grid density is constant. Therefore, the highest required grid density dictates the overall density. From the storage point of view it may, however, be more efficient to have different grid densities in different parts of the cell in this type of scenario. For instance, referring to the above example by dropping the grid density from 100 meters to 400 meters for some sub-areas, the storage consumption decreases to 1/16 for these sub-areas.

In the following, an exemplary order-of-magnitude calculation will be provided. A cell may have a 10-km diameter. The cell is in a rural area so that overall the accuracy requirement is not particularly high. In principle, it would be possible for instance to use a grid with a grid size of 400 m for the cell to obtain an accuracy of approximately 200 meters. However, there is a residential area with 2 km diameter in the cell, in which 50 meter accuracy is preferable, meaning that a grid with a grid size of 100 m is needed in this area. In a conventional approach, the best required accuracy dictates the grid density. Using a conventional approach, a 100 m grid would thus be required for the cell, leading to the need of having approximately 8,000 grid points for covering the cell area. In contrast, if the whole cell is covered with a 400 m basic grid, and only the small 2 km diameter area is covered by a 100 m grid, only 800 grid points are needed. The use of focus grids enabling the use of higher grid densities in selected parts of an area only may thus have the effect of saving storage space while ensuring at the same time a high accuracy in active parts of the area.

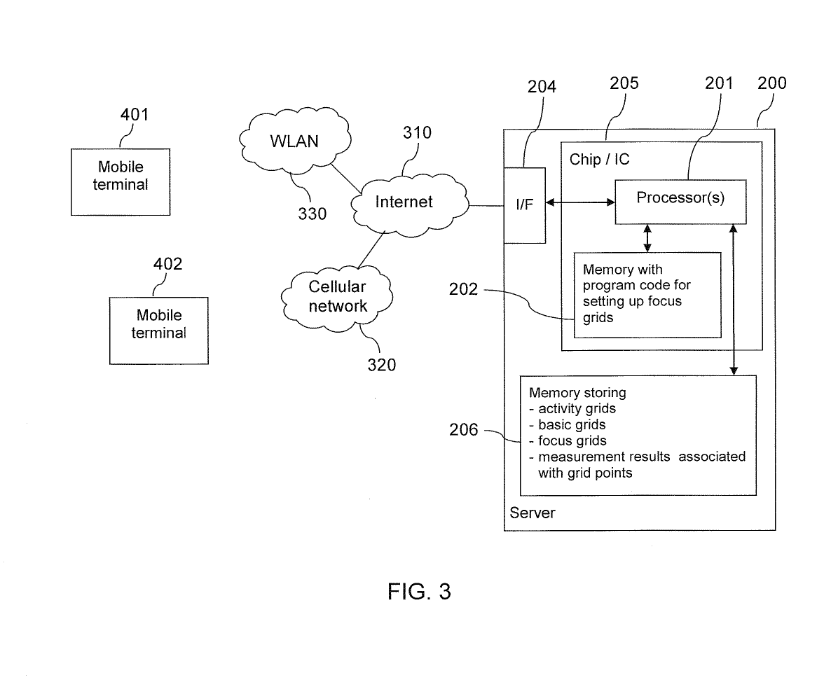

FIG. 3 is a schematic block diagram of a system using focus grids.

The system comprises a server 200. Server 200 is connected to a network 310, for example the Internet. Server 200 could also belong to network 310. Network 310 is suited to interconnect server 200 with mobile terminals 401, 402 via a cellular network 320 or via any of a plurality of WLANs 330.

Server 200 may provide or support a learning system for building up and updating a positioning data learning database, for instance a fingerprint database. Server 200 may be for instance a dedicated positioning server, a dedicated position data learning server, or some other kind of server. It comprises a processor 201 that is linked to a first memory 202, to a second memory 206 and to an interface (IF) 204. Processor 201 is configured to execute computer program code, including computer program code stored in memory 202, in order to cause server 200 to perform desired actions.

Memory 202 stores computer program code for setting up focus grids for selected sub-areas and for causing storage of data based on the focus grids. The computer program code may comprise for example at least similar program code as memory 102. The program code could belong for instance to a comprehensive application supporting a learning of position data and/or supporting a positioning of mobile terminals. In addition, memory 202 may store computer program code implemented to realize other functions, as well as any kind of other data. It is to be understood, though, that program code for any other actions than setting up focus grids could also be implemented on one or more other physical and/or virtual servers.

Processor 201 and memory 202 may optionally belong to a chip or an integrated circuit 205, which may comprise in addition various other components, for instance a further processor or memory.

Memory 206 stores at least one database that can be accessed by processor 201. The database is configured to store measurement data for cells of cellular communication network 320 and for nodes of WLANs 330 on a per cellnode basis. Memory 206 further stores a definition of various grids that form the basis for the storage of the measurement data. The grids could be stored in different forms, e.g. by storing an indication of the location for each single grid point, or by storing an indication of the covered area and an indication of the density of the grid. The definition of the grids may be stored within the database storing the measurement data or separately. In addition, memory 206 could store other data, for instance other data supporting a positioning of mobile terminals. It is to be understood that the memory storing the database and/or the definition of the grids could also be external to server 200; it could be for instance on another physical or virtual server.

Interface 204 is a component which enables server 200 to communicate with other devices, like mobile terminals 401 and 402, via network 310. Interface 204 could comprise for instance a TCP/IP socket.

Component 205 or server 200 could correspond to exemplary embodiments of an apparatus according to the invention.

Cellular communication network 320 comprises a plurality of transceivers operating as nodes of the network. Each WLAN 320 comprises at least one access point as a node of a communication network. Each of the nodes transmits signals that can be observed in certain associated area. In the case of a cellular communication network 320, the area may comprise the area of one or more cells.

Mobile terminals 401, 402 may comprise a GNSS receiver. Mobile terminals 401, 402 may further be configured to perform measurements on signals from nodes of cellular communication network 320 or WLANs 330, for example signal strength measurements. Further, they may be configured to report measurement results taken at different locations to server 200.

During an exemplary operation in the system of FIG. 3, mobile terminal 401 may thus receive satellite signals and determine its current position based on the satellite signals. In addition, mobile terminal 401 may detect signals transmitted by one or more transceivers of cellular network 320 for a respective cell. Mobile device 401 may assemble results of measurements on these signals. It may further associate an identification of a cell with the result or results for at least one cell, for instance a global cell identity and/or a local cell identity. In addition, mobile terminal 401 may detect signals transmitted by access points (AP) of one or more WLANs 330 and associate them with an identity of the WLAN APs. Mobile device 401 may then transmit the measurement results and the associated identification along with an indication of the determined position as a fingerprint in a message to server 200. The transmission may take place via WLAN 330 and network 310 or via cellular network 320 and network 310. It has to be noted that in an alternative embodiment, the position of mobile device 401 could also be determined based on some other positioning technology than GNSS. For instance, mobile terminal 401 could determine its position based on WLAN signals instead of GNSS signals.

Mobile terminal 401 may transmit similar messages from various locations to server 200 while moving around. In addition, other mobile terminals, for instance mobile terminal 402, may transmit corresponding messages to server 200.

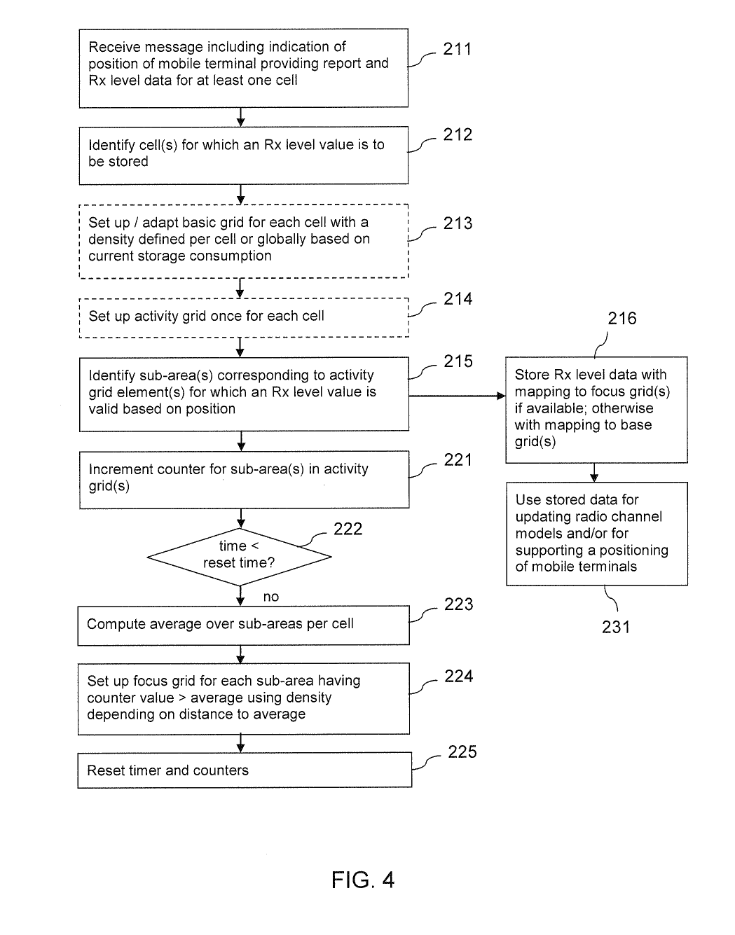

An exemplary operation at server 200 of the system of FIG. 3 will now be described with reference to the flow chart of FIG. 4. Processor 201 and the program code stored in memory 202 cause server 200 to perform the presented operations when the program code is retrieved from memory 202 and executed by processor 201.

Server 200 receives a message with Rx Level data for at least one cell of cellular communication network 320 and an indication of a position of the mobile terminal providing the message. (action 211) Alternatively or in addition, the message could comprise any other kind of data, in particular any other kind of data relating to areas covered by nodes of communication networks.

Server 200 identifies at least one cell for which an Rx Level value is included in the message. (action 212) Server 200 may be configured to identify only a serving cell of the mobile terminal and the associated Rx Level value. Alternatively, server 200 could be configured to identify other cells observed by the mobile terminal for which Rx Level values are included in the message.

Server 200 sets up a basic grid for each identified cell for which measurement results are included and for which such a basic grid has not been set up before. Optionally, server 200 may moreover adjust basic grids for those identified cells for which a basic grid had already been set up before. (action 213)

The density of a respective basic grid could be predetermined and fixed. In this case, the basic grid is only set up once per cell and not adapted later on. Alternatively, the density of the basic grid could be adaptive and be selected for example taking account of the currently used storage space when setting up the basic grid or when adjusting the basic grid.

The density of the basic grid could be the same for all cells or different. For the latter case, a respective storage space could be assigned to each cell, and the density of a basic grid could be determined separately for each cell based on the storage space that is currently consumed for storing data for the cell. A high amount of consumed storage space could result in a reduction of the current density of the basic grid, and a low amount of consumed storage space could result in an increase of the current density of the basic grid.

Taking account of the consumed storage space when selecting the density of a basic grid may have the effect that the consumed storage space can be limited to a desired value. It is to be understood that instead of the current storage consumption, also the remaining free storage space could be considered as a basis. Alternatively or in addition to the storage space, some other criteria could be taken into account, for instance fixed or variable settings in a configuration.

It is to be understood that in another embodiment, server 200 could also select different densities of grid points in latitude and longitude direction for each cell.

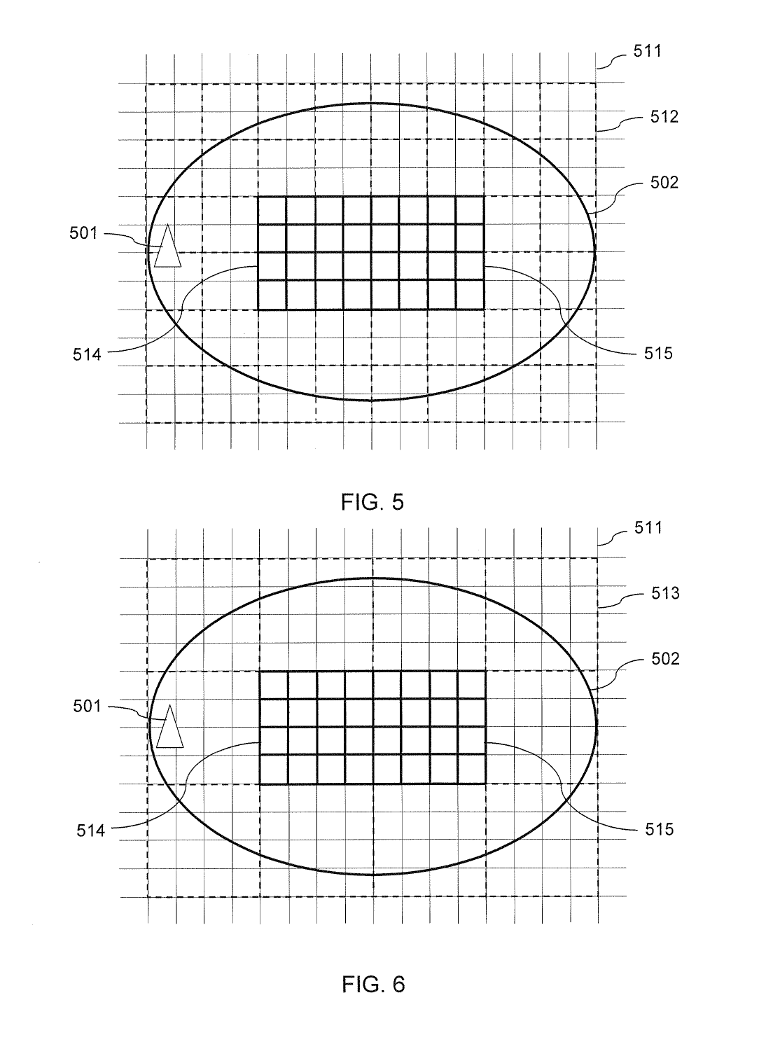

FIG. 5 is a diagram illustrating a basic grid. FIG. 5 shows a cell area 502 in the form of an ellipse, in which signals of a base station 501 can be observed by mobile terminals. A basic grid for this cell is defined such that it covers the entire cell area 502. FIG. 5 shows such a basic grid with dashed lines 512. The basic grid may have by way of example a resolution of 200 meters, or of 0.002 degrees. The density of the basic grid may be reduced by removing rows and/or columns of the basic grid and all associated data. The density of the basic grid may be increased by adding rows and/or columns. The basic grid 512 can be defined for instance with reference to and/or aligned with a close meshed reference grid covering the surface of Earth. For reasons of clarity, only selected lines of such a reference grid are shown in FIG. 5 as thin solid lines 511. These lines 511 could represent for instance every 200th line of the reference grid.

Server 200 further sets up an activity grid for each cell of cellular network 320 for which measurement results are included in a received message and for which such an activity grid has not been set up before. (action 214) Such an activity grid may be set up only once per cell. The activity grid may be used for tracking the activity in sub-areas of the cells and for managing focus grids that will be associated with one or more of the sub-areas.

FIG. 6 is a diagram illustrating an activity grid for the same cell area 502 as depicted in FIG. 5. Like a basic grid, an activity grid for a cell is equally defined such that it covers the entire cell area 502. FIG. 6 shows such an activity grid with dashed lines 513. The activity grid may be rather coarse compared to the basic grid 512. It could have for example a resolution of 400 meters and thus comprises only every second column and row of the basic grid 512.

Server 200 further identifies a sub-area of an identified cell for which a received Rx Level value is valid. (action 215) With the identified cell, the associated activity grid is known, and using the indication of the position of the mobile terminal in the received message, the grid point of the activity grid that is a predefined corner point of a grid element in which the indicated position lies can be selected as a representation of the sub-area.

If server 200 identified a plurality of cells for which an Rx Level value included in the message is to be stored, server 200 determines a corresponding sub-area for each of these cells. If any of the Rx Level values is only associated with a local cell identity in the message, while activity grid, basic grid and measurement results are stored with reference to a global cell identity in memory 206, this may involve a mapping of local cell identities to a respective global cell identity.

Server 200 increments for each considered cell a counter for the grid point of the activity grid corresponding to the determined sub-area. (action 221) The counter may be a part of an object for the grid point of the activity grid, or be referred to by a pointer in an object for the grid point.

As long as a predetermined reset time has not been reached (action 222), server 200 continues with receiving and processing messages as described with reference to actions 211, 212, 213, 214, 215 and 221. Messages may be evaluated for instance during one week for tracking the activity in different sub-areas. During this week, the counters for those sub-areas with high activity will reach higher values than the counters for those sub-areas with low activity. If the mobile terminals are regular user terminals, a high activity in a particular sub-area indicates that this sub-area is of particular interest for users. Consequently, good positioning performance should be provided in this area.

Once the reset time has been reached (action 222), server 200 computes for each cell an average of all counter values of the respective activity grid. (action 223)

Server 200 further determines for each cell those sub-areas that are associated with a counter value which is higher than the average for the cell. For each of these determined sub-areas, server 200 sets up a focus grid with a density that is higher than the density of the basic grid. The density of the focus grids could be fixed to a predetermined value, or it could be set to a fixed absolute or relative difference to the density of the basic grid. Further alternatively, it could be selected depending on the distance of a respective counter value for the sub-area of a cell to the average counter value for the cell, etc. (action 224) An object of the activity grid corresponding to the determined sub-area could comprise a pointer to a table storing the focus grid or to a data entry storing a definition of the focus grid, in particular a definition of its density.

Such a definition could be for instance a factor defining the density of the focus grid compared to the density of a reference grid. Separate factors could be provided for defining the density in latitude and longitude direction.

FIGS. 5 and 6 equally illustrate the use of focus grids for the depicted cell area 502. As can be seen in FIG. 6, focus grids 514, 515 are set up for the two elements of the activity grid 513 in the center of the cell area 502. The elements can be identified for instance by the grid point in the lower left corner of the respective element. As can be seen in FIG. 5, the focus grids 514, 515 have a higher density than the basic grid 512. They could have for instance a double density corresponding to a grid size of 100 meter in the provided example.

It is to be understood that in an alternative embodiment, a single focus grid could be set up for two or more sub-areas, since it may be more efficient to store and use a respective single focus grid instead of a plurality of focus grids, in particular if the focus grids have the same density. In this case, a combined focus grid could be defined for instance by a corner point and the extension of the grid in longitude and latitude direction. If determined sub-areas with high activity are nearby but do not form a rectangle, other sub-areas of lower activity could be covered in addition by the combined focus grid.

For instance, in the following table, “0” could represent sub-areas with low activity, while “X” could represent sub-areas with high activity.

| | | | | |
|---|---|---|---|---|
| 0 | 0 | 0 | 0 | 0 |
| 0 | X | 0 | X | 0 |
| 0 | 0 | X | 0 | 0 |
| 0 | 0 | 0 | 0 | 0 |

It can be seen that the three sub-areas with high activity are close to each other, but they do not form a complete rectangular area. A single focus grid could be assigned in this case to the six sub-areas in the center, including the three sub-areas with high activity and in addition three sub-areas with low activity. These sub-areas are represented in the following table by a respective “F”.

| | | | | |
|---|---|---|---|---|
| 0 | 0 | 0 | 0 | 0 |
| 0 | F | F | F | 0 |
| 0 | F | F | F | 0 |
| 0 | 0 | 0 | 0 | 0 |

The focus grids could be defined as additional grids for each cell. Alternatively, they could also be integrated into the basic grid of a respective cell. In the latter case, the basic grid has a low density in most areas, and an increased density in some selected areas.

If a focus grid had been set up earlier for a particular sub-area, it does not have to be set up again if the density stays the same. If a focus grid had been set up earlier for a particular sub-area, but the density changes, setting up the new focus grid may mean adapting the previous focus grid by adding or removing columns and/or rows. Removing columns and/or rows implies removing the associated stored data as well.

Once focus grids have been set up for all identified cells, the timer and all counters for all sub-areas in all activity grids of all cells may be reset. (action 225) It is to be understood that in another exemplary embodiment, different reset timers could be used for different cells or different sets of cells.

The counters may then be incremented again based on newly received messages until the reset time is reached again. It is to be understood, however, that the setting up of focus grids does not have to be performed continuously. The counters could be incremented for instance based on the messages that are received during a week. After a reset, server 200 may then wait for a month or a year before starting anew with incrementing the counters based on received messages. Further alternatively, no timer could be used and actions 222 and 225 could be omitted. In this case, the counters are simply incremented continuously, and focus grids could be set up based on the current counter values after each receipt of a new message with measurement results, after receipt of a predetermined number of messages, or periodically, etc.

When sub-areas have been identified for one or more cells in action 215, this information is used in parallel for storing the Rx Level values. (action 216) It may be checked first for each concerned cell whether there is a focus grid for the determined sub-area by checking the activity grid for the respective cell. If a focus grid is available, the indicated position is mapped to a grid point of the focus grid and the Rx Level value and any other associated information is stored with reference to this grid point in memory 206. Otherwise, the indicated position is mapped to a grid point of the basic grid of the respective cell and the Rx Level value is stored with reference to this grid point in memory 206. It is to be understood that in case new focus grids are set up in response to the receipt of the current message (action 224), the included measurement results could also be stored only after the set up of the new focus grids.

In an alternative embodiment, the Rx Level values and any associated information could be stored in action 216 with a mapping to a grid point of the basic grid of the respective cell in any case. One or more focus grids, if available for the relevant sub-area, are then updated in addition.

The data may be stored in various ways. The selected grid—that is, focus grid or basic grid—could be represented for instance by a table that is stored in the database in memory 206, and the measurement results and associated data could be inserted as an entry of the table. It is to be understood, however, that the storage of the data does not require storage of the entire grid or of a table corresponding to the entire grid. Since many grid points may not have any data associated with them so far, the data could be stored for instance efficiently using a run-length encoding in the database. Further alternatively, the indices of the grid points, with which data are associated, followed by the respectively associated data could be stored in a sequence in the database.

The data stored in memory 206 may be used for regularly updating further models, for example radio channel models, or for supporting a positioning of mobile terminals directly. (action 231)

It has to be noted that also mobile terminals with GNSS capability may benefit from using cellular non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

Furthermore, it has to be understood that also a mobile terminal might benefit from an implementation using focus grids for storing data for different nodes. For instance, a mobile terminal could be configured to collect a large number of samples for various nodes before providing the data to a server. In the meantime, the mobile terminal could set up focus grids, map results of measurements and associated data to grid points of basic grids and focus grids as appropriate, and store the mapped data in an internal memory, in a similar manner as described with reference to FIG. 4 for server 200.

Summarized, certain embodiments of the invention may thus have the effect of enabling the storage of data with different densities for different sub-areas of an area. This may ensure a high accuracy mapping of available measurement results in sub-areas of high activity, and thus, for instance a high positioning accuracy, while keeping the storage consumption as low as desired in general.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s) software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 205 can also be viewed as means for determining for each of a plurality of sub-areas of an area an amount of measurement results that are received for the respective sub-area; means for determining a sub-area, for which the determined amount of measurement results exceeds a reference value; and means for setting up for the determined sub-area a focus grid with a density that is higher than a lowest density of a basic grid assigned to the area, wherein measurement results received for the determined sub-area are to be stored at least with a mapping to grid points of the focus grid.

The program codes in memory 102 and 202, respectively, can also be viewed as comprising such means in the form of functional modules.

FIGS. 2 and 4 may also be understood to represent exemplary functional blocks of a computer program code for supporting an efficient storage of measurement results.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-24. (canceled)

25. A method comprising at an apparatus:
determining for each of a plurality of sub-areas of an area an amount of measurement results that are received for the respective sub-area;
determining a sub-area, for which the determined amount of measurement results exceeds a reference value; and
setting up for the determined sub-area a focus grid with a density that is higher than a lowest density of a basic grid assigned to the area, wherein measurement results received for the determined sub-area are to be stored at least with a mapping to grid points of the focus grid.

26. The method according to claim 25, wherein the measurement results are results of measurements on signals from a particular node of a communication network.

27. The method according to claim 25, wherein the amount of measurement results is a number of measurement results per time period.

28. The method according to claim 25, wherein the reference value is one of
a fixed threshold value; and
an average over an amount of measurement results from all considered sub-areas of the area.

29. The method according to claim 25, wherein the focus grid is one of
provided in addition to the basic grid; and
integrated into the basic grid.

30. The method according to claim 25, wherein a plurality of focus grids are assigned to a plurality of sub-areas of the area, and wherein each of the focus grids for the sub-areas of the area has one of
the same density; and
an individually selected density.

31. The method according to claim 25, wherein setting up a focus grid comprises storing at least one factor defining a density of the focus grid in relation to a density of a reference grid.

32. The method according to claim 25, further comprising storing measurement results for a sub-area for which a respective focus grid has been set up with a mapping to grid points of the respective focus grid, taking account of the grid density of the respective focus grid.

33. The method according to claim 25, further comprising retrieving measurement results that are stored with a mapping to grid points of a focus grid, and processing the data taking account of the grid density of the respective focus grid.

34. An apparatus comprising at least one processor and at least one memory including computer program code, the at least one memory and the computer program code configured to, with the at least one processor, cause an apparatus at least to perform:
determine for each of a plurality of sub-areas of an area an amount of measurement results that are received for the respective sub-area;
determine a sub-area, for which the determined amount of measurement results exceeds a reference value; and
set up for the determined sub-area a focus grid with a density that is higher than a lowest density of a basic grid assigned to the area, wherein measurement results received for the determined sub-area are to be stored at least with a mapping to grid points of the focus grid.

35. The apparatus according to claim 34, wherein the measurement results are results of measurements on signals from a particular node of a communication network.

36. The apparatus according to claim 34, wherein the amount of measurement results is a number of measurement results per time period.

37. The apparatus according to claim 34, wherein the reference value is one of
a fixed threshold value; and
an average over an amount of measurement results from all considered sub-areas of the area.

38. The apparatus according to claim 34, wherein the focus grid is one of
provided in addition to the basic grid; and
integrated into the basic grid.

39. The apparatus according to claim 34, wherein the computer program code is configured to, with the at least one processor, cause an apparatus to assign a plurality of focus grids to a plurality of sub-areas of the area, and wherein each of the focus grids for the sub-areas of the area has one of
the same density; and
an individually selected density.

40. The apparatus according to claim 34, wherein setting up a focus grid comprises storing at least one factor defining a density of the focus grid in relation to a density of a reference grid.

41. The apparatus according to claim 34, wherein the computer program code is further configured to, with the at least one processor, cause an apparatus to store measurement results for a sub-area for which a respective focus grid has been set up with a mapping to grid points of the respective focus grid, taking account of the grid density of the respective focus grid.

42. The apparatus according to claim 34, wherein the computer program code is further configured to, with the at least one processor, cause an apparatus to retrieve measurement results that are stored with a mapping to grid points of a focus grid, and processing the data taking account of the grid density of the respective focus grid.

43. The apparatus according to claim 34, wherein the apparatus is one of:
a server;
a component for a server;
a mobile terminal; and
a component for a mobile terminal.

44. A non-transitory computer readable storage medium in which computer program code is stored, the computer program code when executed by a processor causing an apparatus to perform the following:
determine for each of a plurality of sub-areas of an area an amount of measurement results that are received for the respective sub-area;
determine a sub-area, for which the determined amount of measurement results exceeds a reference value; and
set up for the determined sub-area a focus grid with a density that is higher than a lowest density of a basic grid assigned to the area, wherein measurement results received for the determined sub-area are to be stored at least with a mapping to grid points of the focus grid.
